(19) United States
(12) Patent Application Publication
(10) Pub. No.: US 2016/0223482 A1
(43) Pub. Date: Aug. 4, 2016

(54) DEVICE AND METHOD TO PERFORM NON-DESTRUCTIVE TESTING OF THE QUALITY OF COATING FOR THE HOLLOW INTERIORS OF PARTS

(71) Applicant: ATAHUALPA OSCAR GARCIA DELGADO, The Woodlands, TX (US)

(72) Inventor: ATAHUALPA OSCAR GARCIA DELGADO, The Woodlands, TX (US)

(21) Appl. No.: 14/603,319

(22) Filed: Jan. 22, 2015

(51) Int. Cl. G01N 27/02

(52) U.S. Cl. CPC G01N 27/026

(57) ABSTRACT

This invention refers to a device and method that permits the evaluation of the quality of the coating applied in the hollow interior of a part, via non-destructive, electro-chemical testing. This device allows the hollow interior of the part to be isolated and sealed from the rest of the part, allowing the electrolyte solution to only be in contact with the hollow interior of the part being tested.

This application is based upon and claims priority from U.S. Provisional application Ser. No. 61/930,054, which is incorporated herein by reference.

### BACKGROUND OF THE INVENTION

1. Field of the Invention

Applicants' invention relates to a device for the non-destructive testing of the quality of the coating in the interiors of parts and method for using same.

### BACKGROUND INFORMATION

Currently, there are no methods available for testing the quality of coating application for the hollow interior of parts that are non-destructive. For example, X-Rays and Eddy Current tests require cutting the part to access the interior and examine the required area. This leaves the tested part useless.

### SUMMARY OF THE INVENTION

The following described device and method presents an option for non-destructive testing of the coating for the hollow interior of any part. This device and method allows one to use electro-chemical testing; for example, electrochemical impedance Spectroscopy, linear resistance to polarization, etc. This allows verifying the quality of the coating via non-destructive testing.

With this device and method, it will allow applying the linear resistance to polarization test for the hollow interior of the part. This test is a very inexpensive, fast, and non-destructive way to determine the quality of the coating. It also allows one to determine any defects in the hollow, interior coated part, identifying and preventing future possible failures of the part in service.

With this device and method, it will allow applying electrochemical impedance Spectroscopy for the hollow interior of the part. This test is time consuming, but a non-destructive way to determine the porosity, discontinuity, and contaminants of the coating in the hollow interior of the part. This device allows the hollow interior of the part to be isolated and sealed from the rest of the part, allowing the electrolyte solution to only be in contact with the hollow interior of the part being tested.

The electro-chemical techniques just described require a device which will allow the correct and easy utilization of an electro-chemical cell that isolates the hollow interior from the part itself. It will allow the electrolyte solution to be in contact with the hollow interior of the part. The device allows the correct configuration of the 3 electrodes of an electro-chemical cell in the isolated hollow interior of the part. Connecting the 3 electrodes to a potentiostat/galvanostat will allow one to apply the different electro-chemical non-destructive tests to determine the quality of the coating in the hollow interior part. Subsequent to the testing, this same part can be used as designed for service, being totally unaffected by the device and methods described herein. The described device and method verify the quality of the coating in the hollow interior part in a non-destructive manner, thereby allowing the use of the same part for future service. This device and method allows parts to be tested for the quality of coating in the hollow interior of the part before released to service, providing confidence that defects in the hollow interior of the part are minimized when the part goes to service.

### BRIEF DESCRIPTION OF THE DRAWINGS

FIG. 1 is a perspective view of the present invention.

FIG. 2 is a side view of the present invention.

FIG. 3 is a top view of the present invention.

FIG. 4 is a perspective view of the present invention with electrodes.

### DETAILED DESCRIPTION OF THE PREFERRED EMBODIMENT

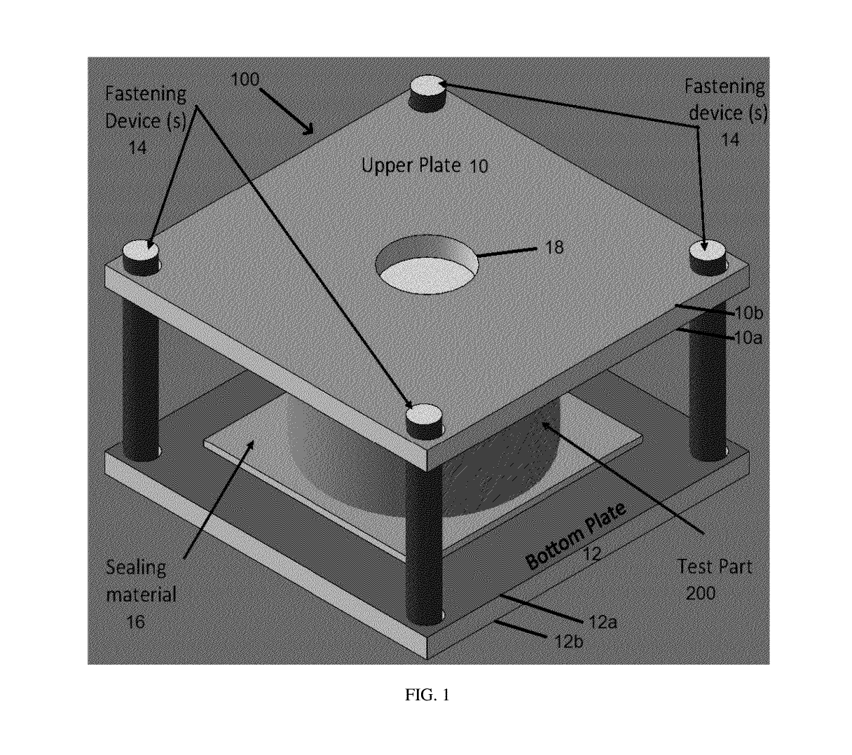

Referring to the figures, FIG. 1 is a three dimensional view of the testing apparatus 100. The testing apparatus 100 has a upper plate 10 and a bottom plate 12. Each of the upper 10 and bottom 12 plates have non-contact surfaces (10b and 12b) and contact surfaces (10a and 12a). The contact surfaces (10a and 12a) are held generally parallel to, and facing, each other. The upper 10 and bottom 12 plates are held on opposing sides of a test part 200 using one or more fastening devices 14. The upper plate 10 has an aperture 18 that allows the positioning of the electrodes (202 and 204). The bottom plate 12 will hold and isolate the hollow interior of the part 200. The bottom plate 12 will also make electrical contact with the part 200 being tested.

The testing apparatus 100 seals the hollow interior of the test part 200 from the rest of the part 200 to allow an electrolyte solution to be placed in contact with the hollow interior portion being tested. This permits electro-chemical, non-destructive testing to be performed in the hollow interior of the part 200. These tests can include, without limitation, linear resistance to polarization and electrochemical impedance spectroscopy. The device 100 is integrated with an upper plate 10 that contains a hole 18, allowing electrodes to pass through the upper plate 10 and contact the electrolyte solution. This permits the correct configuration of the electro-chemical cell to perform the test. One, or more, fastening devices 14 compress the upper 10 and bottom 12 plates to hold and seal the part 200 subject to testing. The aperture 18 can be placed in line with the hollow portion of the test part 200 so as to allow testing to be conducted on the hollow interior portion of the test part 200 isolated from the remainder of said test part 200.

The exterior of the part 200 being tested is connected with an electrical contact to close the system for an electro-chemical test. The fastening device(s) 14 hold, compress, and seal the tested part 200 between the two plates (10 and 12). The fastening device(s) 14 are distributed in such a fashion as to allow a good seal to occur between the plates (10 and 12) and the part 200.

The bottom plate 12 may have a sealing material 16. Once the tested part 200 is secured between the upper 10 and bottom 12 plates secured by one or more of the fastening devices 14, the electrodes inserted through the hole 18 of the upper plate 10 and contact the solution in the hollow interior of the part 200.

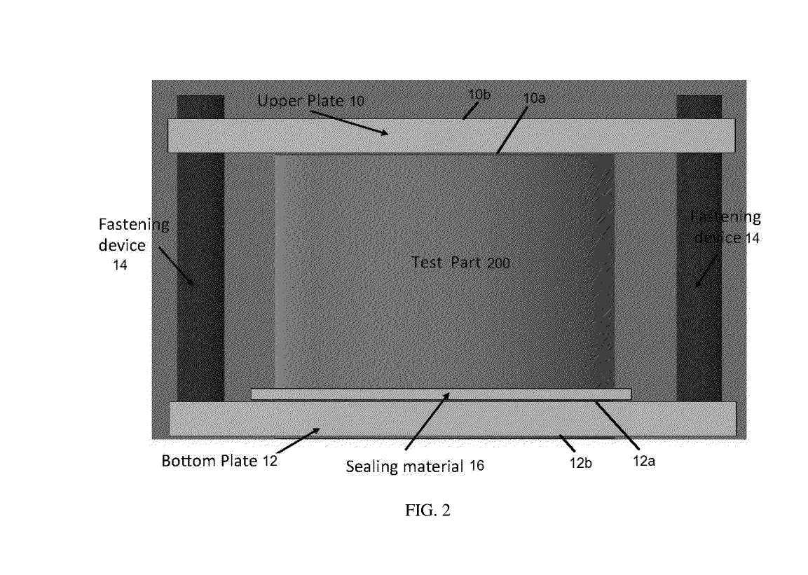

FIG. 2 is a side view of the device 100, which includes both the upper 10 and bottom 12 plates. There is a sealing material 16 between the tested part 200 and the contact surface 12a of the bottom plate 12. The fastening devices 14 can be seen holding the upper 10 and lower 12 plates in place. In between the upper 10 and bottom 12 plates is the exterior of the part 200 being tested. The electrical contact surface for the exterior of the tested part 200 is also shown.

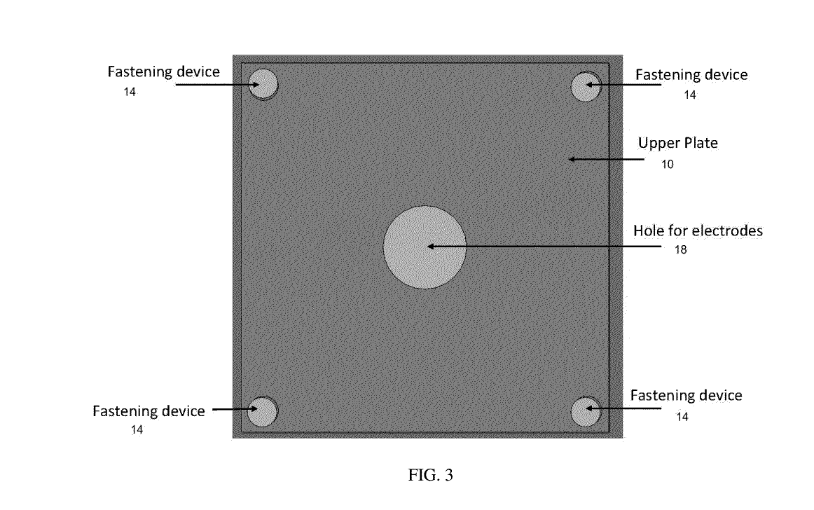

FIG. 3 is a top view of the device, the non-contact surface 10b of the upper plate 10 being visible with the fastening devices 14 shown at the corners of the upper plate 10. It is anticipated however, that the upper plate 10 could be of varying shapes and thus the fastening devices 14 would be placed so as to seal the test part 200 between the plates (10 and 12). In the central portion of the upper plate 10, there is a hole 18 for the electrodes (202 and 204) to pass through and contact the solution (not shown). Except for in the aperture 18 and the interior of the test part 200, the solution (not shown) is held out of contact of the test part 200 by the upper plate 10.

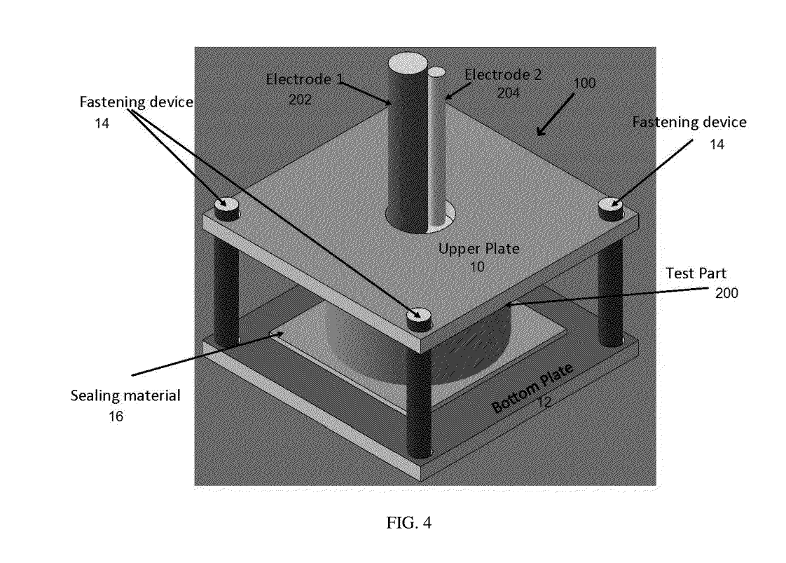

FIG. 4 is a three dimensional view of the device assembly 100. It is holding a cylindrical part 200 between the upper 10 and bottom 12 plates. Electrodes (202 and 204) are inserted in the hole 18 in the central portion of the upper plate 10, passing through to be in contact with the solution.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. I claim a testing apparatus comprising:
an upper plate having a contact surface and an aperture in the central portion of said upper plate;
a bottom plate having a contact surface;
one or more fastening devices holding said upper plate contact surface generally parallel and facing said bottom plate contact surface;
said upper and bottom plates capable of holding a test part between them in conjunction with said fastening devices;
a sealing material disposed between said bottom plate and said test part; and
wherein said aperture can be placed in line with the hollow portion of said test part so as to allow testing to be conducted on the hollow interior portion of said test part isolated from the remainder of said test part.

2. The apparatus of claim 1 wherein said test part hollow interior portion may be tested for quality of its coating before being released for service.

3. The apparatus of claim 1 wherein said test part hollow interior portion may be tested for quality of its coating without damaging said test part.

4. The apparatus of claim 1 wherein said upper plate and said bottom plate seal the hollow interior of said test part and permits the correct configuration of an electro-chemical cell.

5. The apparatus of claim 4 wherein said upper plate and said bottom plate hold an electrolyte solution in the interior of said test part so as to allow performance of electro-chemical tests in the hollow interior of said test part.
